(19) United States
(12) Patent Application Publication
(10) Pub. No.: US 2005/0139399 A1
(43) Pub. Date: Jun. 30, 2005

(54) Hybrid electric propulsion system, hybrid electric power pack and method of optimizing duty cycle

(75) Inventor: Ravi B. Gopal, Oakville (CA)

Correspondence Address: OGILVY RENAULT LLP, 1981 MCGILL COLLEGE AVENUE, SUITE 1600, MONTREAL, QC, H3A2Y3, CA

(73) Assignee: HYDROGENICS CORPORATION, Mississauga (CA)

(21) Appl. No.: 11/020,187

(22) Filed: Dec. 27, 2004

Related U.S. Application Data
(60) Provisional application No. 60/532,953, filed on Dec. 30, 2003.
(60) Provisional application No. 60/539,993, filed on Jan. 30, 2004.

(51) Int. Cl. B60K 1/00

(52) U.S. Cl. 180/65.1

(57) ABSTRACT

A fuel cell powered vehicle includes a fuel cell power module having at least one fuel cell electrically connected to a drive unit for delivering power to the drive unit, a battery pack having at least one battery electrically connected to the drive unit for independently delivering power to the drive unit, and an ultra-capacitor pack having at least one ultra-capacitor electrically connected to the drive unit for independently delivering power to the drive unit. When the power requirement is low, only the fuel cell power module delivers electric power to the drive unit. The battery pack supplements the power to the drive unit for medium power requirements. The ultra-capacitor pack supplements the power to the drive unit for high power requirements. The ultra-capacitor pack can be recharged by regenerative braking.

### CROSS-REFERENCE TO RELATED APPLICATIONS

This application claims priority from U.S. Provisional Patent Application Ser. No. 60/532,953 filed Dec. 30, 2003 and from U.S. Provisional Patent Application Ser. No. 60/539,993 filed Jan. 30, 2004.

### FIELD OF THE INVENTION

The present invention relates generally to hybrid electric power generation and delivery to vehicles or equipment subject to sharp transient power draws and, in particular, to a hybrid electric propulsion system for a fuel cell powered vehicle, to a hybrid electric power pack and to a method of optimizing their respective duty cycles.

### BACKGROUND OF THE INVENTION

A fuel cell is an electrochemical device that produces an electromotive force by bringing the fuel (typically hydrogen) and an oxidant (typically air) into contact with two suitable electrodes and an electrolyte. A fuel, such as hydrogen gas, for example, is introduced at a first electrode where it reacts electrochemically in the presence of the electrolyte to produce electrons and cations in the first electrode. The electrons are circulated from the first electrode to a second electrode through an electrical circuit connected between the electrodes. Cations pass through the electrolyte to the second electrode. Simultaneously, an oxidant, such as oxygen or air is introduced to the second electrode where the oxidant reacts electrochemically in the presence of the electrolyte and a catalyst, producing anions and consuming the electrons circulated through the electrical circuit. The cations are consumed at the second electrode. The anions formed at the second electrode or cathode react with the cations to form a reaction product. The first electrode or anode may alternatively be referred to as a fuel or oxidizing electrode, and the second electrode may alternatively be referred to as an oxidant or reducing electrode. The half-cell reactions at the first and second electrodes respectively are:
H₂→2H⁺+2e⁻ (1)
½O₂+2H⁺+2e⁻→H₂O (2)

The external electrical circuit withdraws electrical current and thus receives electrical power from the fuel cell. The overall fuel cell reaction produces electrical energy as shown by the sum of the separate half-cell reactions shown in equations 1 and 2. Water and heat are typical by-products of the reaction.

In practice, fuel cells are not operated as single units. Rather, fuel cells are connected in series, either stacked one on top of the other or placed side by side. The series of fuel cells, referred to as a fuel cell stack, is normally enclosed in a housing. The fuel and oxidant are directed through manifolds in the housing to the electrodes. The fuel cell is cooled by either the reactants or a cooling medium. The fuel cell stack also comprises current collectors, cell-to-cell seals and insulation while the required piping and instrumentation are provided external to the fuel cell stack. For the purposes of this specification, the term “fuel cell” means a single fuel cell or a fuel cell stack having a plurality of fuel cells. A fuel cell power module generally has a fuel cell stack which is connected to an operating system (also known as balance-of-plant or BOP), which supplies the necessary process fluids to the stack and regulates the operation of the fuel cells that make up the fuel cell stack.

Although the advantages of generating electric power using fuel cells are numerous, one notable shortcoming is that fuel cells tend to exhibit a response lag when subjected to a sharp transient load (i.e. a sudden demand for power). In other words, fuel cells tend to exhibit a relatively slow dynamic response to sharply transient load variations, i.e. they have a limited load slew rate. Rapid transients occur, for instance, in a fuel cell powered vehicle during acceleration or in a stationary application, e.g. an auxiliary power unit (APU), when a large load is imposed on the fuel cell power module. One solution to this problem has been to use large air blowers to provide a sufficient amount of oxidant to the fuel cell stack. However, this approach tends to result in fuel cells that are large, heavy and expensive. Furthermore, even with large air blowers, the fuel cell stacks still suffer from a discernable lag time between the demand for power and its delivery, which is due largely to mass transport limitations.

Another approach has been to marry fuel cells with battery packs to provide hybrid electric propulsion. Some examples of hybrid electric propulsion systems can be found in U.S. Pat. No. 5,631,532 entitled FUEL CELL/BATTERY HYRBID POWER SYSTEM FOR VEHICLE to Azuma et al; U.S. Pat. No. 5,760,488 entitled VEHICLE HAVING A FUEL CELL OR BATTERY ENERGY SUPPLY NETWORK to Sonntag; U.S. Pat. No. 6,321,145 entitled METHOD AND APPARATUS FOR A FUEL CELL PROPULSION SYSTEM to Rajashekara; and U.S. Pat. No. 6,580,977 entitled HIGH EFFICIENCY FUEL CELL AND BATTERY FOR A HYBRID POWERTRAIN to Ding et al. However, a battery pack can only be recharged at a fairly modest rate which is problematic for regenerative braking where a rapid return of energy cannot be fully captured by the batteries, which instead tend to overheat. In other words, an unacceptably large proportion of the return energy from regenerative braking is lost as heat if the batteries are subjected to too much charge. Furthermore, although batteries can contribute a useful amount of power, they tend to be heavy, bulky, of limited durability and often contain toxic chemicals which are incompatible with fuel cell applications where hazardous spills or emissions must be strictly avoided. The foregoing therefore represents a substantial impediment to the effective implementation of fuel cell technology for vehicles and other applications subject to sharply transient loads.

Fuel cell power modules supplemented by both batteries and ultra-capacitors are also known in the prior art, such as the system and method disclosed in U.S. Pat. No. 6,497,974 entitled FUEL CELL POWER SYSTEM, METHOD OF DISTRIBUTING POWER, AND METHOD OF OPERATING A FUEL CELL POWER SYSTEM to Fuglevand. Ultra-capacitors can be discharged and recharged at a higher rate than batteries, which makes ultra-capacitors useful for applications such as powering vehicles. However, in the Fuglevand system, the fuel cells, ultra-capacitors and batteries are wired in parallel with the load such that the voltage across each element is the same. Accordingly, as will be appreciated by those of ordinary skill in the art, the charging and de-charging of the batteries and ultra-capacitors becomes dependent on the current and voltage of the other components, which thus complicates control and limits overall system performance.

Thus, there remains a need for a hybrid power pack or propulsion system capable of rapid response to sharply transient loads.

### SUMMARY OF THE INVENTION

It is therefore an object of the present invention to provide a hybrid power pack or propulsion system capable of rapid response to sharply transient loads.

The present invention therefore provides a fuel cell powered vehicle including a drive unit for receiving electric power and converting the electric power into a propulsive force to displace the vehicle; a fuel cell power module having at least one fuel cell electrically connected to the drive unit for delivering power to the drive unit; a battery pack having at least one battery electrically connected to the drive unit for independently delivering supplemental power to the drive unit; and an ultra-capacitor pack having at least one ultra-capacitor electrically connected to the drive unit for independently delivering supplemental power to the drive unit.

In one embodiment, the vehicle further includes a controller for receiving a power requirement signal representative of an instantaneous power requirement of the vehicle, the controller causing a battery pack to deliver power to the drive unit when the instantaneous power requirement exceeds a maximum power output of the fuel cell power module and further causing an ultra-capacitor pack to deliver power to the drive unit when the instantaneous power requirement exceeds a combined maximum power output of the fuel cell power module and the battery pack.

The present invention further provides a method of powering a vehicle having a fuel cell power module having at least one fuel cell, the fuel cell power module being selectively supplemented by a battery pack having at least one battery and an ultra-capacitor pack having at least one ultra-capacitor. The method includes the steps of: receiving a power requirement signal representing an instantaneous power requirement of the vehicle; processing the power requirement signal to determine whether the instantaneous power requirement of the vehicle can be satisfied by the fuel cell power module alone, by the fuel cell power module supplemented by the battery pack, or by the fuel cell power module supplemented by both the battery pack and the ultra-capacitor pack; supplying electric power to a drive unit of the vehicle from the fuel cell power module; supplementing the electric power delivered to the drive unit by also independently delivering power from the battery pack when the instantaneous power requirement exceeds a maximum power output of the fuel cell power module; supplementing the electric power delivered to the drive unit by also independently delivering power from the ultra-capacitor pack when the instantaneous power requirement exceeds a combined maximum power output of the fuel cell power module and the battery pack.

In one embodiment, the method further includes the step of simultaneously charging both the battery pack and the ultra-capacitor pack using current from the fuel cell power module when the instantaneous power requirement is less than the maximum power output of the fuel cell power module.

In another embodiment, the method further includes the step of charging the ultra-capacitor pack using current generated by the drive unit during regenerative braking of the vehicle.

The present invention further provides a hybrid electric propulsion system including: a drive unit for receiving electric power and converting the electric power into a propulsive force; a fuel cell power module having at least one fuel cell electrically connected to the drive unit for delivering power to the drive unit; a battery pack having at least one battery electrically connected to the drive unit for independently delivering power to the drive unit; and an ultra-capacitor pack having at least one ultra-capacitor electrically connected to the drive unit for independently delivering power to the drive unit.

In one embodiment, the propulsion system further includes a controller for receiving a power requirement signal representative of an instantaneous power requirement, the controller causing a battery pack to deliver power to the drive unit when the instantaneous power requirement exceeds a maximum power output of the fuel cell power module and further causing an ultra-capacitor pack to deliver power to the drive unit when the instantaneous power requirement exceeds a combined maximum power output of the fuel cell power module and the battery pack.

The present invention further provides a hybrid power pack for generating and delivering electric power to equipment having sharply transient power requirements. The power pack includes: a power output unit for supplying electric power to the equipment; a fuel cell power module having at least one fuel cell electrically connected to the power output unit for generating and delivering electric power to the power output unit; a battery pack having at least one battery electrically connected to the power output unit for selectively and independently delivering electric power to the power output unit; and an ultra-capacitor pack having at least one ultra-capacitor electrically connected to the power output unit for selectively and independently delivering electric power to the power output unit.

In one embodiment, the power pack further includes a controller for receiving a power requirement signal representative of an instantaneous power requirement, the controller causing a battery pack to deliver power to the power output unit when the instantaneous power requirement exceeds a maximum power output of the fuel cell power module and further causing an ultra-capacitor pack to deliver power to the power output unit when the instantaneous power requirement exceeds a combined maximum power output of the fuel cell power module and the battery pack.

The present invention further provides a method of outputting electric power in response to a sharply transient power requirement. The method includes the steps of: receiving a power requirement signal representing an instantaneous power requirement; processing the power requirement signal to determine whether the instantaneous power requirement can be satisfied by the fuel cell power module alone, by the fuel cell power module supplemented by the battery pack, or by the fuel cell power module supplemented by both the battery pack and the ultra-capacitor pack; outputting electric power from the fuel cell power module; supplementing the electric power delivered by the fuel cell power module by also independently outputting electric power from a battery pack when the instantaneous power requirement exceeds a maximum power output of the fuel cell power module; supplementing the electric power delivered by the fuel cell power module and the battery pack by also independently outputting electric power from an ultra-capacitor pack when the instantaneous power requirement exceeds a combined maximum power output of the fuel cell power module and the battery pack.

In one embodiment, the method further includes the step of simultaneously charging both the battery pack and the ultra-capacitor pack using current from the fuel cell power module when the instantaneous power requirement is less than the maximum power output of the fuel cell power module.

In another embodiment, the method further includes the step of charging the ultra-capacitor pack using current generated by a freely rotating electric motor.

In yet another embodiment, the method further includes the steps of transducing an actual power output of the power pack into a feedback signal; returning the feedback signal to a controller for comparison with a power setpoint set by a user; and controlling the electric power delivered by the fuel cell power module, battery pack and ultra-capacitor pack in response to a difference between the power setpoint and the feedback signal.

The foregoing aspects of the present invention provide a fuel cell power module capable of rapid response to sharply transient loads. Because electric power delivered by the fuel cell power module is supplemented, when needed, by the battery pack and the ultra-capacitor pack, the size, weight and mass flow requirements of the fuel cell power module remain optimally small. Accordingly, the present invention efficiently provides hybrid electric power for propelling a vehicle or supplying power in a hybrid power pack. Since the battery pack and ultra-capacitor pack are discharged only when needed, the duty cycle of the propulsion system (or power pack) is optimized.

### BRIEF DESCRIPTION OF THE DRAWINGS

Having thus generally described the nature of the invention, reference will now be made to the accompanying drawings, in which:

FIG. 1 is a schematic side view of a hybrid electric propulsion system for a vehicle in accordance with an embodiment of the present invention;

FIG. 2 is a schematic side view of a mine in which a vehicle having the hybrid electric propulsion system of FIG. 1 can be used;

FIG. 3 is a graph of power draw as a function of time illustrating a typical duty cycle for a vehicle having the hybrid propulsion system in accordance with the present invention;

FIG. 4 schematically depicts the hybrid propulsion system in accordance with the present invention, shown delivering high torque;

FIG. 5 schematically depicts the hybrid propulsion system in accordance with the present invention, shown delivering medium torque;

FIG. 6 schematically depicts the hybrid propulsion system in accordance with the present invention, shown delivering low torque;

FIG. 7 schematically depicts the hybrid propulsion system in accordance with the present invention, shown recharging an ultra-capacitor pack during regenerative braking;

FIG. 8 schematically depicts a hybrid power pack in accordance with another embodiment of the present invention, shown delivering high power;

FIG. 9 schematically depicts the hybrid power pack in accordance with another embodiment of the present invention, shown delivering medium power;

FIG. 10 schematically depicts the hybrid power pack in accordance with another embodiment of the present invention, shown delivering low power; and

FIG. 11 schematically depicts the hybrid power pack in accordance with another embodiment of the present invention, shown recharging an ultra-capacitor pack.

### DETAILED DESCRIPTION OF THE PREFERRED EMBODIMENTS

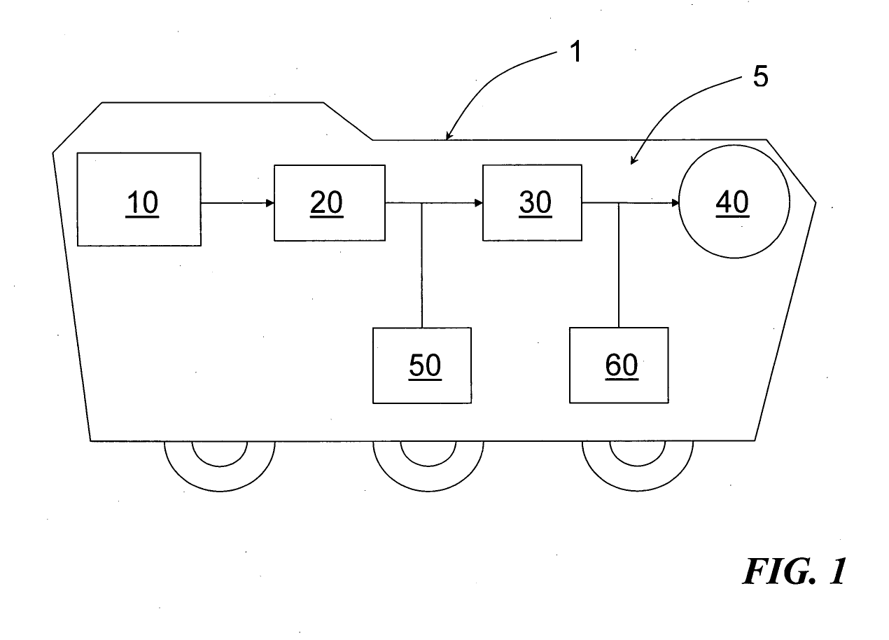

FIG. 1 shows a schematic side view of a fuel cell powered vehicle generally designated by reference numeral 1 in accordance with an embodiment of the present invention. The fuel cell powered vehicle 1 is propelled by a hybrid electric propulsion system 5 which provides electric power to at least one drive unit 40, e.g. an electric motor. The drive unit 40 receives the electric power and converts the electric power into a propulsive force to displace the vehicle. The hybrid electric propulsion system 5 includes a fuel cell power module (FCPM) 10 for generating and supplying electric power to the drive unit 40. The hybrid electric propulsion system 5 further includes a battery pack 50 and an ultra-capacitor pack 60 for independently supplementing, when needed, the power delivered by the fuel cell power module 10.

For the purposes of this specification, the expressions “independently supplementing”, “independently delivering” and “independently outputting” refer to the capability of both the battery pack and ultra-capacitor pack to deliver power to the drive unit without affecting the energy state of the other component. By enabling the battery and ultra-capacitor packs to deliver power independently of each other, control of the system is facilitated and system performance is improved. In other words, by electrically decoupling the battery pack and the ultra-capacitor pack, the system can more flexibly and efficiently respond to an instantaneous power requirement.

The hybrid electric propulsion system 5 also has a first power electronics module 20 and a second power electronics module 30 disposed as shown in FIG. 1. The first and second power electronics modules control power distribution in the vehicle. The first power electronics module 20 is either unidirectional, i.e. it allows electric current to pass only one way, or it is bi-directional, i.e. it allows electric current to pass both ways past the module. Similarly, the second power electronics module 30 is either unidirectional or bi-directional, which allows power to flow back to the battery pack or ultra-capacitor pack for recharging. The power electronics used in the present invention are operable in, but not limited to, voltage, current or power limited modes.

The fuel cell power module 10 generally includes a fuel cell stack (not shown) having at least one fuel cell, and the necessary balance-of-plant machinery (also not shown) to allow the fuel cell power module 10 to operate.

As shown in FIG. 1, a battery pack 50 is connected to the propulsion unit 5 so that the battery pack can feed electric power into the drive unit 40 via the second power electronics module 30. The battery pack 50 has at least one battery and individual batteries may be connected in series and/or parallel as required to reach a desired power output (current and voltage). The battery pack could contain any type of batteries.

An ultra-capacitor pack 60 is connected to provide electric power to the drive unit 40. In one embodiment, the drive unit 40 can also provide electric power to recharge the ultra-capacitor pack. The ultra-capacitor pack 60 includes at least one ultra-capacitor to provide a desired total electric charge capacity.

Ultra-capacitors are made using advanced manufacturing techniques (double-layer), which allow extremely high power density (both volumetrically and gravimetrically). They were originally used where high power density was required (digital cameras and other consumer electronics). Recently high current and high capacity ultra-capacitors have been introduced, which make them very attractive for PEM (Proton Exchange Membrane) fuel cell applications. Table 1 below compares the key elements of ultra-capacitors versus other energy storage/generating means:

TABLE 1

| | | | Ultra- |
|---|---|---|---|
| | Fuel Cell | Battery | capacitor |
| Acquisition Cost | High | Low | Medium |
| Energy delivery | Excellent | Very | Poor |
| capability | | good | |
| Instant power | Poor | Good | Excellent |
| capability | | | |
| Power density | Good | Good | Excellent |
| (gravimetric) | | | |
| Power density | Average | Good | Excellent |
| (volumetric) | | | |

Ultra-capacitors and fuels cell clearly appear to be a good match for a complete energy solution: Fuel cells are essentially energy generation devices with relatively poor instant power capabilities while ultra-capacitors excel in delivering instant power but have very low energy storage capacity.

Another benefit of matching ultra-capacitors and fuel cells is overall cost: Instead of sizing a fuel cell for peak power, a smaller unit could be used, coupled with ultra-capacitors for extra power when needed. As fuel cell power modules are still quite expensive (even versus ultra-capacitors), this contributes to lower the overall cost of a fuel cell-based generator. In addition, ultra-capacitors are made with non-toxic materials, which makes them better suited for fuel cell applications than batteries. However, batteries provide a convenient long-term storage of electric energy, which can be utilized in parallel with the electric energy provided by the fuel cell power module to power a load at a power level higher than what the fuel cell power module can achieve alone. Thus, in applications where the battery composition is no hindrance, the present invention utilizes a fuel cell power module having an ultra-capacitor unit, for enhanced transient load performance, and a battery unit, for enhanced long-term heavy load performance.

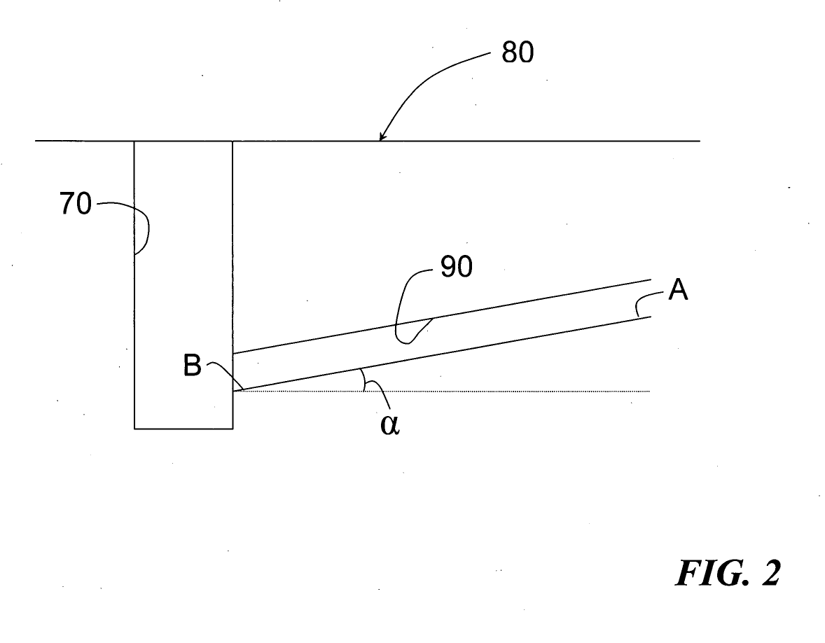

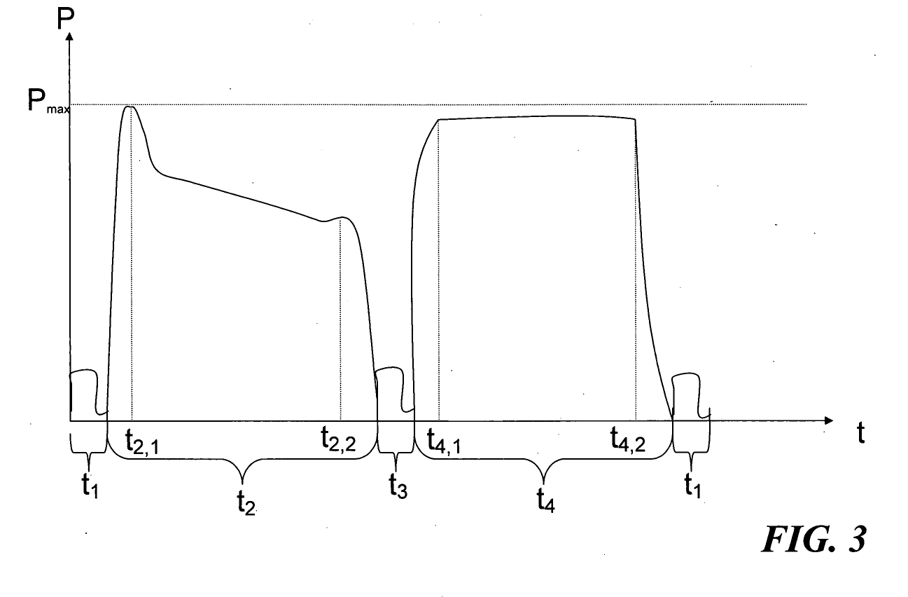

FIGS. 2 and 3 illustrate a method of powering a hybrid electric vehicle having a fuel cell power module having at least one fuel cell, the fuel cell power module being selectively supplemented by a battery pack having at least one battery and an ultra-capacitor pack having at least one ultra-capacitor. To illustrate the method of powering the hybrid vehicle, reference will be made to an electric mining locomotive for transporting ore from a loading site to a unloading site and returning empty. This example is intended to be illustrative only, and is of course not intended to limit the present invention to the type of vehicle described. As persons of ordinary skill in the art will readily appreciate, the hybrid propulsion system can be used in cars, buses, trucks, subways, watercraft and any other type of vehicle that can be powered by a fuel cell.

Therefore, for the purposes of illustration only, FIG. 2 shows a typical underground mine having a shaft 70 extending down from the surface 80. A mining tunnel 90 extends out from the shaft and has a loading site A, distant from the shaft, and an unloading site B, adjacent the shaft. Ore is transported from the unloading site to the surface using a lift (not shown) in the shaft. The tunnel is made with a built-in grade of an angle α so that the tunnel is higher where point A is located than where point B is located. In this way, any water collecting in the tunnel will run down the slope to the shaft. Naturally, the tunnel may be drilled directly into a sufficiently vertical mountain surface, without the need for a shaft.

FIG. 3 shows the instantaneous power requirement for the locomotive during its duty cycle, starting with a first time period t₁ during which the propulsion unit 5 is used to power the locomotive and its train of unloaded cars departing from the loading site. At the start, there is only a small power requirement, for instance, to power lights and perhaps a climate control unit (neither of which is shown). The FCPM 10 can handle this low power requirement on its own, i.e. without contributions from the battery pack 50 or the ultra-capacitor pack 60. Period t₁ typically lasts about 5 minutes.

During the following time period, t₂, the locomotive pulls loaded train cars from the loading site to the unloading site. A relatively large power draw is now required to pull the loaded train cars. The FCPM powers the locomotive, assisted by the battery pack 50 and the ultra-capacitor pack 60 at peak power demand (at the beginning of t₂ and until t_{2,1}). After an initial power peak due to the inertia of the train cars, the power draw is lower, utilizing power to pull the heavy cars down the slope. Period t₂ typically lasts about 30 minutes. When the locomotive approaches the unloading site, beginning at t_{2,2}, the train starts to coast and eventually to brake in preparation for the stop. The ultra-capacitor pack 60 is then charged by electric power taken from the drive unit 40 acting as a generator during coasting/braking. When the locomotive reaches the unloading site, the train cars are unloaded with ore during the time period t₃. No power is required from the propulsion unit 5 during this time, except what may be required to keep external systems such as locomotive cabin heater/coolers running and/or brake systems operational (see time period t₁). The FCPM is used to recharge the battery pack 50 during this time. Period t₃ typically lasts about 5-10 minutes. When the train cars are unloaded, the locomotive starts the transport of the train cars back to the loading site, during time period t₄. Since the cars are now pulled up the slope, a relatively large power draw is present, comparable to the transport of the loaded cars down the slope, necessitating the simultaneous use of electric power from the FCPM 10, the battery pack 50 and the ultra-capacitor pack 60 from t_{4,1}. When the locomotive approaches the loading site, at t_{4,2}, the train set starts to coast and eventually to brake in preparation for the stop. The ultra-capacitor pack 60 is then again charged by electric power taken from the drive unit 40 acting as a generator during coasting/braking. Period t₄ typically lasts about 30-50 minutes.

Thus, the FCPM 10 has a maximum power capacity that is substantially lower than the maximum instantaneous power requirement P_{MAX} during the duty cycle of the vehicle. To satisfy the maximum instantaneous power requirement, the battery pack 50 and the ultra-capacitor pack 60 are made to discharge so as to contribute electric power to the drive unit. Thus, the battery pack and ultra-capacitor pack must be charged during the duty cycle. However, if the locomotive has been inactive for a certain period of time, for example during loading or unloading, the battery pack and the ultra-capacitor pack may have to be charged using auxiliary equipment. Alternatively, the locomotive can start its duty cycle by idling or transporting a lighter load, as a way of building up sufficient charge in both the battery pack and the ultra-capacitor pack.

By using a smaller FCPM 10 having a lower current output, it is possible to provide a hybrid electric propulsion unit 5 which is very cost effective both at purchase as well as during use. The ultra-capacitor pack is designed to withstand over 500,000 duty cycles before replacement. Similarly, the battery pack is selected to have an acceptably large number of charge-discharge cycles so that the batteries in the battery pack need only be replaced at regular, acceptably spaced maintenance intervals.

The ultra-capacitor pack includes at least one ultra-capacitor, such as, for example, an ultra-capacitor available from Maxwell Technologies of San Diego, Calif., U.S.A. As is well known in the art, capacitors store energy in the form of separated electrostatic charge. The capacitance is proportional to the area of the plates, and inversely proportional to the distance between the plates. A regular capacitor has flat, charged plates which are often separated by a dielectric material, such as plastic, paper film or ceramic. An ultra-capacitor, on the other hand, uses a porous carbon-based electrode material. The porous structure increases its effective surface area so that it approaches effectively about 2000 square meters per gram, which is substantially larger than conventional capacitors using flat plates. Furthermore, the effective distance between the charges in an ultra-capacitor is determined by the size of the ions in the electrolyte which are attracted to the charged electrode, using less than 10 angstroms, which is much smaller than what can be achieved using conventional dielectric materials. The combined effect of a huge effective surface area and an extremely tiny charge separation confers extremely high capacitance.

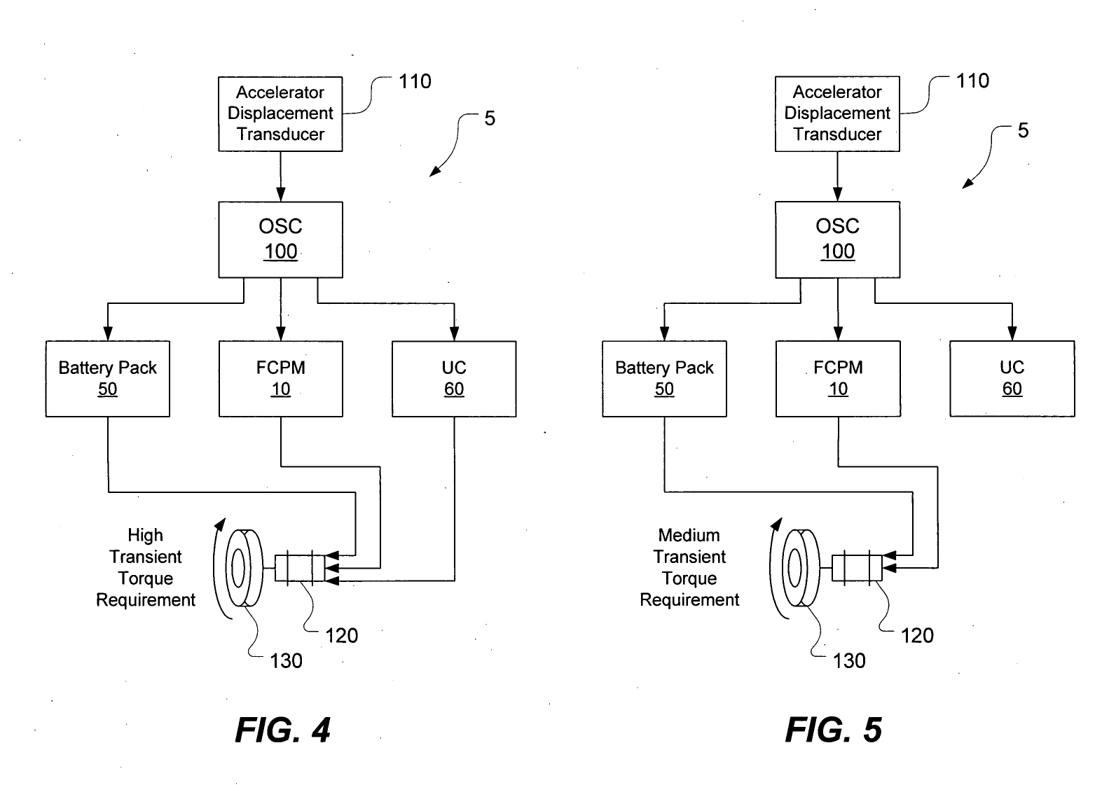

FIGS. 4 to 7 schematically illustrate various modes of operation of a vehicle having a hybrid electric propulsion system in accordance with the present invention. FIG. 4 shows the vehicle in a “high-torque mode” in response to a high transient torque requirement, e.g. heavy loads and/or rapid acceleration. For the purposes of this specification, “transient torque requirement” shall mean the time rate of change of required torque. Analogously, the expression “transient power requirement” shall mean the time rate of change of required power. As is known in the art, vehicle power is a measurement of the work performed per unit time (watts or horsepower) whereas torque is a measurement of the moment or couple causing the drive wheels to rotate (Newton-meters or foot-pounds).

Due to the time lag of the fuel cell power module, the actual rate of change of torque (or power) lags behind the required rate of change of torque (or power). Electrically, this corresponds to a sudden demand for high current. In other words, the actual current drawn from the propulsion system lags behind the current demand. By discharging the battery pack and/or the ultra-capacitor pack, the lag can be substantially reduced so that the response curve more closely tracks the instantaneous power requirement of the vehicle.

As shown in FIGS. 4 to 7, the hybrid propulsion system 5 includes a fuel cell power module 10 having at least one fuel cell electrically connected to the drive unit for delivering power to the drive unit 40. The hybrid propulsion system 5 also includes a battery pack 50 having at least one battery electrically connected to the drive unit 40 for independently delivering supplemental power to the drive unit. The hybrid propulsion system 5 further includes an ultra-capacitor pack 60 having at least one ultra-capacitor electrically connected to the drive unit 40 for independently delivering supplemental power to the drive unit.

In one embodiment, the fuel cell power module 10 is also electrically connected to the battery pack for charging the battery pack. In another embodiment, the fuel cell power module 10 is electrically connected to both the battery pack 50 and the ultra-capacitor pack 60 for recharging both the battery pack and the ultra-capacitor pack. In yet a further embodiment, the drive unit 40 is further connected to the ultra-capacitor pack 60 via a recharge circuit adapted to recharge the ultra-capacitor pack 60 during regenerative braking of the vehicle.

In further embodiments, the hybrid propulsion system 5 includes a controller (or overall system controller) 100 for receiving a power requirement signal representative of an instantaneous power requirement of the vehicle, the controller having control logic for efficiently coordinating the fuel cell power module, battery pack and ultra-capacitor pack in response to the power requirement signal. For example, the controller 100, upon receipt of the power requirement signal representative of the instantaneous power requirement of the vehicle, can cause the battery pack to independently deliver power to the drive unit when the instantaneous power requirement exceeds a maximum power output of the fuel cell power module and to further cause the ultra-capacitor pack to independently deliver power to the drive unit when the instantaneous power requirement exceeds a combined maximum power output of the fuel cell power module and the battery pack.

As shown in FIG. 4, when the hybrid propulsion system 5 is operating in high transient torque mode, the FCPM 10, the battery pack 50 and the ultra-capacitor pack 60 all independently contribute electric power to the drive unit 120. Due to the sudden high current requirement, the fuel cell power module 10, due to its inherent lag time, cannot react quickly enough to deliver the needed current. Thus, the battery pack discharges current from its stored electrochemical potential into the drive unit to supplement the current already being delivered by the fuel cell power module to the drive unit. Simultaneously, the ultra-capacitor pack discharges its stored, electrostatic energy, delivering yet more current to the drive unit. The ultra-capacitor pack delivers a very high current for a short duration, thus enabling the drive unit to draw a high current to response to the suddenly increased power requirement. By the time the current from the ultra-capacitor pack has tapered off, the fuel cell power module has had time to ramp up its power output. The battery pack supplies less current than the ultra-capacitor pack but for a longer duration. The battery pack thus also instantaneously supplements the electric power being delivered by the fuel cell power module, allowing the fuel cell to ramp up its power output to the needed current draw.

The ultra-capacitor pack and battery pack not only independently contribute power to satisfy the suddenly increased power demand, but also provide a power “bridge” that effectively curtails the fuel cell lag thus enabling the fuel cell power module to ramp up its power output to satisfy the high torque requirement.

FIG. 5 shows schematically the vehicle running in a medium torque mode in response to a medium transient torque requirement. The sudden increase in required current in this mode is greater than what the fuel cell power module can furnish and thus the battery pack is solicited to supplement the total power output to the drive unit by also delivering current. In this scenario, the FCPM 10 and the battery pack 50 are contributing electric power to the drive unit 120. In medium-power mode, the ultra-capacitor pack 60 is inactive since the current draw can be satisfied by the FCPM and the battery pack in concert.

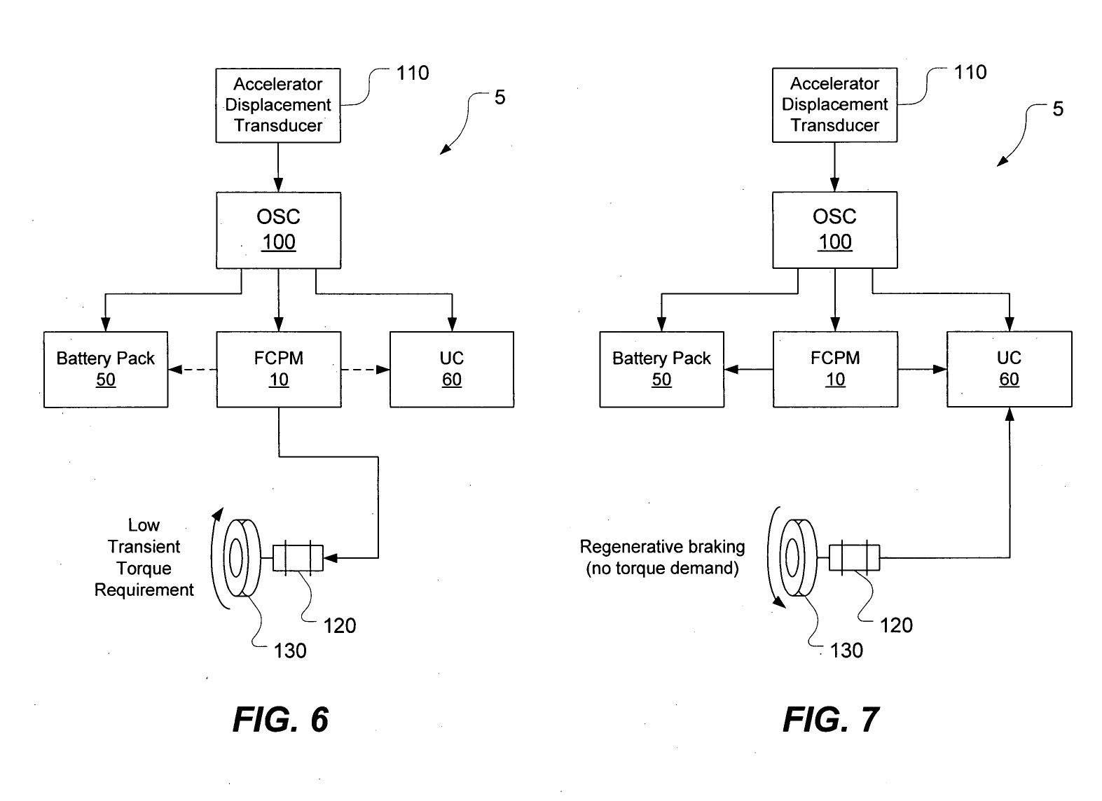

FIG. 6 shows schematically the vehicle running in low-torque mode in which only the FCPM 10 delivers electric power to the drive unit 120. In low-torque mode, the transient torque requirement is low, meaning that the time rate of change of required torque is small. Since the time derivative of required torque is small, the fuel cell power module 10 is thus able to ramp up its power generation with negligible or acceptably minimal lag. In low-power mode, if surplus power output is available, the FCPM 10 can also simultaneously recharge the battery pack 50 and/or the ultra-capacitor pack 60.

FIG. 7 shows schematically the vehicle running in regenerative-braking mode. During regenerative braking or coasting, the drive unit (e.g. a reversible electric motor) functions as an electric generator, generating an electric current that can be used to recharge the ultra-capacitor pack (and/or the battery pack). The electric motor can also be used to regenerate power for recharging the battery pack or both the battery pack and ultra-capacitor pack.

Additional battery packs and/or ultra-capacitor packs can be added to provide a greater number of modes. For example, a tiered set of ultra-capacitor packs could be triggered in a staggered manner to provide a more sustained maximum power. In another embodiment, two or more ultra-capacitor packs could be either triggered simultaneously (for extremely high power output) or sequentially (for sustained high-end output). As will be appreciated by those of ordinary skill in the art, there are many readily apparent variations on the embodiments presented herein.

The vehicle has an overall system controller (OSC) 100 (analogous to an electronic control module, ECM, on an internal combustion engine) which receives a power requirement signal from an accelerator displacement transducer 110. The power requirement signal is representative of an instantaneous power requirement as determined by the driver of the vehicle. As will be readily appreciated by those of ordinary skill in the art, other sensors/transducers could be substituted for the accelerator displacement transducer depending on the manner in which acceleration or power output is controlled in a given vehicle. The overall system controller 100 receives the power requirement signal from the accelerator displacement transducer and then processes the signal to determine a power generation mode, i.e. high-power mode, medium-power mode, or low-power mode. These modes can be alternatively designated as high-torque mode, medium-torque mode, or low-torque mode. Each mode (high, medium and low) corresponds effectively to an electric current draw that must be furnished to the drive unit (i.e. one or more electric motors) to produce the needed torque at the wheel(s).

If the OSC 100 determines that the instantaneous power requirement is such that is merely in low-power mode (e.g., coasting, idling or minimal acceleration) then the OSC send a signal to the FCPM to deliver power to the drive unit 120, e.g. an electric drive motor. If the OSC 100 determines that the instantaneous power requirement exceeds the upper limit for the low-power mode, then the OSC sends a signal not only to the FCPM to deliver electric power to the drive unit but also to the battery pack 50 so that it too delivers electric power to the drive unit. The battery pack 50 is thus solicited to supplement the electric power of the FCPM in medium-torque mode, i.e. when a medium torque must be delivered to the wheel 130 (or wheels) of the vehicle. If the OSC 100 determines that the instantaneous power requirement exceeds the upper limit for the medium-power mode, then the OSC sends signals to the FCPM 10, the battery pack 50 and to the ultra-capacitor pack 60. In high-power mode, all three subsystems independently contribute to the power output of the propulsion system. Each ultra-capacitor in the ultra-capacitor pack is capable of discharging very high currents (e.g., circa 100 amps) for a short duration (e.g. about 5 seconds after which the current has diminished to about half) so that a sharp transient, i.e. a suddenly high power requirement, can be satisfied while the fuel cell power module ramps up more slowly.

In the foregoing illustration, the OSC 100 processes the power requirement signal by determining the appropriate power mode based on the rate of change of the required current draw. However, it is also possible for the OSC 100 to implement more sophisticated control algorithms which also depend on the recent history of the instantaneous power requirement (e.g. by integration of the power requirement over time) and/or on the second time derivative of the instantaneous power requirement (i.e. the rate of change of the rate of change of the required power). Alternatively, a control algorithm could be designed to predict lag time or the response curve of the fuel cell at any given operating condition, and to correlate the predicted response curve with the time-varying instantaneous power requirement of the vehicle. Indeed, as it should become apparent to those of ordinary skill in the art, there are numerous ways to control the propulsion system without departing from the spirit and scope of the present invention.

As was illustrated in FIGS. 2 and 3, the overall system controller 100 can implement any number of control algorithms designed to optimize the duty cycle of a particular vehicle performing under particular conditions, by defining power tiers or echelons at which the various subsystems (FCPM, battery pack, ultra-capacitor pack) become operative. Furthermore, the propulsion system 5 can have a greater or lesser reliance on ultra-capacitors, i.e. the ratio of energy stored electrostatically in ultra-capacitors versus the energy stored electrochemically in batteries, depending on the vehicle and its probable duty cycle. Where the vehicle is subject to very high transient loads (e.g. a subway locomotive or a city bus), the design of the propulsion system 5 will place a greater emphasis on energy stored electrostatically using ultra-capacitors. On the other hand, for a vehicle with less drastic transient loads (e.g. a car designed to cruise on the highway), the design of the propulsion system will put a greater emphasis on storing energy electrochemically using batteries.

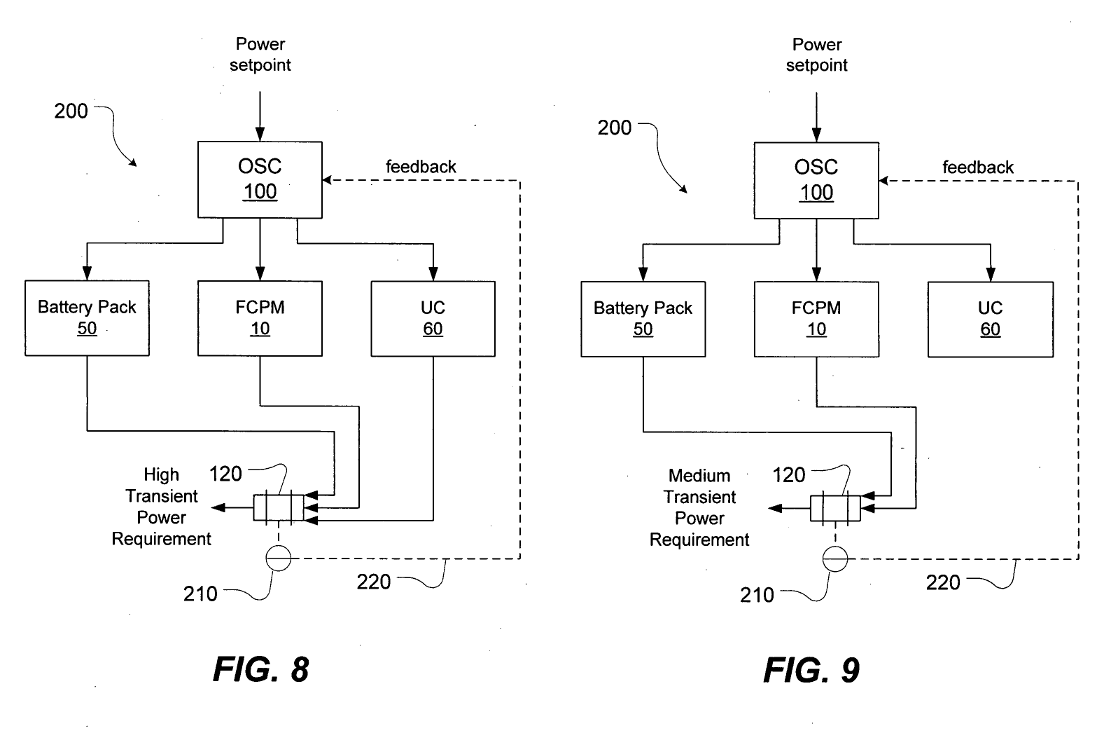

FIGS. 8 to 11 illustrate schematically the operation of a hybrid power pack 200 in accordance with another embodiment of the present invention. The hybrid power pack 200 includes a fuel cell power module 10 (FCPM) having at least one fuel cell, a battery pack 50 having at least one battery, and an ultra-capacitor pack 60 (UC) having at least one ultra-capacitor. The fuel cell power module, battery pack and ultra-capacitor are electrically connected to a power output unit 120, e.g. an electric motor. The hybrid power pack 200 further includes an overall system controller 100 for controlling the fuel cell power module, the battery pack 50 and the ultra-capacitor pack 60 in response to a power requirement signal representative of an instantaneous power requirement. The hybrid power pack 200 further includes a transducer 210 for transducing (either continually or intermittently) an actual power output by the power output unit 120 into a feedback signal 220 which is fed back to the overall system controller 100. The transducer 210 can be any number of known sensors for measuring current and voltage, for example, or alternatively other performance indicia such as torque or RPM.

As shown in FIGS. 8 to 11, the overall system controller (OSC) 100 receives not only the feedback signal 220 but also a power setpoint (i.e., the instantaneous power requirement) that is typically set by a user. The controller 100 compares the feedback signal 220 to the power setpoint (instantaneous power requirement) and then controls (i.e. readjusts) the electric power delivered by the fuel cell power module, battery pack and ultra-capacitor pack in response to a difference between the power setpoint and the feedback signal. Alternatively, the controller can control the various subsystems (FCPM, battery pack, ultra-capacitor pack) in response not only to the error (difference between setpoint and feedback values) but also as a function of recent power requirements or time rate of change of power requirements, or by using other known control algorithms. In another embodiment, the transducer transduces an instantaneous power requirement of a connected load into a feedback signal (representative of the actual current draw). The feedback signal is then returned to the controller for computation using pre-programmed or dynamically changeable control algorithms and parameters, which are known in the art of control systems. The controller can then determine the readiness of the power pack to sustain the power demand. The controller accordingly controls the ability of the fuel cell power module, battery pack and ultracapacitor pack to deliver electric power in response to a difference between the determined or calculated setpoint and the feedback signal. The controller can also process the rate of change of the feedback signal to project an estimated demand.

In FIG. 8, the hybrid power pack 200 is shown satisfying a high transient power requirement. When the power requirement increases steeply, the fuel cell power module, battery pack and ultra-capacitor contribute to the electric power delivered to the power output unit. In response to a sharp power requirement spike, the fuel cell power module 10 begins to ramp up delivery of current to the power output unit 120. The battery pack 50 and the ultra-capacitor pack discharge to supplement the electric power being delivered to the power output unit so that the total current draw becomes high for a short period of time, thereby satisfying the sharp transient load.

In FIG. 9, the hybrid power pack 200 is shown outputting electric power to satisfy a medium transient power requirement, i.e. a medium increase in power demand. In this scenario, the battery pack 50 supplements the electric power delivered by the ramping-up fuel cell power module 10 while the ultra-capacitor 60 sits idle.

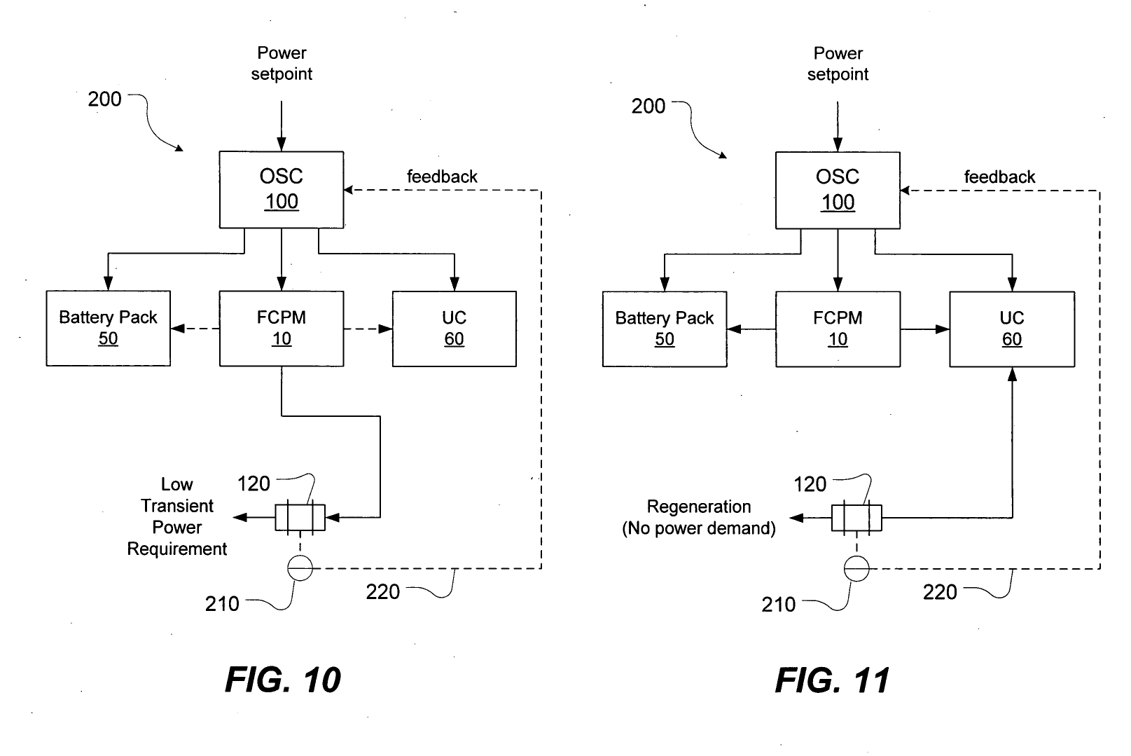

In FIG. 10, the hybrid power pack 200 is shown meeting a low transient power requirement, i.e. a mild increase in power demand. In this scenario, the fuel cell power module 10 is capable of meeting the increasing power requirement on its own, i.e. without any contributions from the battery pack 50 and ultra-capacitor pack 60, which thus remain idle. In other words, the fuel cell power module ramps up its power output so that the instantaneous power requirement is satisfied with a negligible, or at least a minimal, lag.

Furthermore, as shown in FIG. 10, the fuel cell power module 10 is electrically connected to both the battery pack 50 and the ultra-capacitor pack 60. The fuel cell power module is capable of charging or recharging the battery pack 50 and ultra-capacitor pack 60 via respective charging circuits that are schematically represented by the dotted lines linking the FCPM 10 with both the battery pack 50 and the ultra-capacitor pack 60. When the power requirement is less than the maximum power output of the fuel cell power module, the overall system controller 100 can be designed to direct the fuel cell power module to charge (or recharge) the battery pack and/or the ultra-capacitor pack.

In FIG. 11, the hybrid power pack 200 is shown in a no-load condition where, depending on the reversibility of the electric motor being used as the power output unit 120, it is possible to regenerate electric power. As is known in the art, a reversible electric motor can effectively become an electric generator as it rotates freely (i.e. under no applied current). Electrical current generated by the reversible electric motor (which is thus functioning as a generator) can then be used to recharge the ultra-capacitor. Thus, the ultra-capacitor can be recharged by both the power output unit 120 acting as a generator and by excess current from the fuel cell power module 10. The battery pack can also be recharged by the fuel cell power module 10. In a variant, the power output unit 120 functioning as a generator can recharge the battery pack 50 in addition to, or in lieu of, recharging the ultra-capacitor pack 60.

The hybrid power pack can be used in a variety of stationary, non-vehicular applications, such as auxiliary power units (APUs) for providing backup power generation, or for powering electrically driven machinery in situations or environments where it would be advantageous to generate clean power using fuel cell technology. As will be appreciated by those of ordinary skill in the art, the hybrid power pack of the present invention has widespread application in a large number of devices, apparatuses and machines having sharp transient loads and where clean power is desirable.

Modifications and improvements to the above-described embodiments of the present invention may become apparent to those skilled in the art. The foregoing description is intended to be exemplary rather than limiting. The scope of the invention is therefore intended to be limited solely by the scope of the appended claims.

I/We claim:

1. A fuel cell powered vehicle comprising:
a drive unit for receiving electric power and converting the electric power into a propulsive force to displace the vehicle;
a fuel cell power module having at least one fuel cell electrically connected to the drive unit for delivering power to the drive unit;
a battery pack having at least one battery electrically connected to the drive unit for independently delivering supplemental power to the drive unit; and
an ultra-capacitor pack having at least one ultra-capacitor electrically connected to the drive unit for independently delivering supplemental power to the drive unit.

2. The vehicle as claimed in claim 1 wherein the fuel cell power module is electrically connected to the battery pack for charging the battery pack.

3. The vehicle as claimed in claim 1 wherein the fuel cell power module is electrically connected to both the battery pack and the ultra-capacitor pack for recharging both the battery pack and the ultra-capacitor pack.

4. The vehicle as claimed in claim 1 wherein the drive unit is further connected to the ultra-capacitor pack via a recharge circuit adapted to recharge the ultra-capacitor pack during regenerative braking of the vehicle.

5. The vehicle as claimed in claim 2 wherein the drive unit is further connected to the ultra-capacitor pack via a recharge circuit adapted to recharge the ultra-capacitor pack during regenerative braking of the vehicle.

6. The vehicle as claimed in claim 3 wherein the drive unit is further connected to the ultra-capacitor pack via a recharge circuit adapted to recharge the ultra-capacitor pack during regenerative braking of the vehicle.

7. The vehicle as claimed in claim 1 further comprising a controller for receiving a power requirement signal representative of an instantaneous power requirement of the vehicle, the controller having control logic for efficiently coordinating the fuel cell power module, battery pack and ultra-capacitor pack in response to the power requirement signal.

8. The vehicle as claimed in claim 1 further comprising a controller for receiving a power requirement signal representative of an instantaneous power requirement of the vehicle, the controller causing a battery pack to deliver power to the drive unit when the instantaneous power requirement exceeds a maximum power output of the fuel cell power module and further causing an ultra-capacitor pack to deliver power to the drive unit when the instantaneous power requirement exceeds a combined maximum power output of the fuel cell power module and the battery pack.

9. The vehicle as claimed in claim 2 further comprising a controller for receiving a power requirement signal representative of an instantaneous power requirement of the vehicle, the controller causing a battery pack to deliver power to the drive unit when the instantaneous power requirement exceeds a maximum power output of the fuel cell power module and further causing an ultra-capacitor pack to deliver power to the drive unit when the instantaneous power requirement exceeds a combined maximum power output of the fuel cell power module and the battery pack.

10. The vehicle as claimed in claim 3 further comprising a controller for receiving a power requirement signal representative of an instantaneous power requirement of the vehicle, the controller causing a battery pack to deliver power to the drive unit when the instantaneous power requirement exceeds a maximum power output of the fuel cell power module and further causing an ultra-capacitor pack to deliver power to the drive unit when the instantaneous power requirement exceeds a combined maximum power output of the fuel cell power module and the battery pack.

11. The vehicle as claimed in claim 4 further comprising a controller for receiving a power requirement signal representative of an instantaneous power requirement of the vehicle, the controller causing a battery pack to deliver power to the drive unit when the instantaneous power requirement exceeds a maximum power output of the fuel cell power module and further causing an ultra-capacitor pack to deliver power to the drive unit when the instantaneous power requirement exceeds a combined maximum power output of the fuel cell power module and the battery pack.

12. The vehicle as claimed in claim 5 further comprising a controller for receiving a power requirement signal representative of an instantaneous power requirement of the vehicle, the controller causing a battery pack to deliver power to the drive unit when the instantaneous power requirement exceeds a maximum power output of the fuel cell power module and further causing an ultra-capacitor pack to deliver power to the drive unit when the instantaneous power requirement exceeds a combined maximum power output of the fuel cell power module and the battery pack.

13. The vehicle as claimed in claim 6 further comprising a controller for receiving a power requirement signal representative of an instantaneous power requirement of the vehicle, the controller causing a battery pack to deliver power to the drive unit when the instantaneous power requirement exceeds a maximum power output of the fuel cell power module and further causing an ultra-capacitor pack to deliver power to the drive unit when the instantaneous power requirement exceeds a combined maximum power output of the fuel cell power module and the battery pack.

14. A method of powering a vehicle having a fuel cell power module having at least one fuel cell, the fuel cell power module being selectively supplemented by a battery pack having at least one battery and an ultra-capacitor pack having at least one ultra-capacitor, the method comprising the steps of:
receiving a power requirement signal representing an instantaneous power requirement of the vehicle;
processing the power requirement signal to determine whether the instantaneous power requirement of the vehicle can be satisfied by the fuel cell power module alone, by the fuel cell power module supplemented by the battery pack, or by the fuel cell power module supplemented by both the battery pack and the ultra-capacitor pack;
supplying electric power to a drive unit of the vehicle from the fuel cell power module;
supplementing the electric power delivered to the drive unit by also independently delivering power from the battery pack when the instantaneous power requirement exceeds a maximum power output of the fuel cell power module; and
supplementing the electric power delivered to the drive unit by also independently delivering power from the ultra-capacitor pack when the instantaneous power requirement exceeds a combined maximum power output of the fuel cell power module and the battery pack.

15. The method as claimed in claim 14 further comprising the step of charging the battery pack using current from the fuel cell power module when the power requirement is less than the maximum power output of the fuel cell power module.

16. The method as claimed in claim 14 further comprising the step of simultaneously charging both the battery pack and the ultra-capacitor pack using current from the fuel cell power module when the instantaneous power requirement is less than the maximum power output of the fuel cell power module.

17. The method as claimed in claim 14 further comprising the step of charging the ultra-capacitor pack using current generated by the drive unit during regenerative braking of the vehicle.

18. A hybrid electric propulsion system comprising:
a drive unit for receiving electric power and converting the electric power into a propulsive force;
a fuel cell power module having at least one fuel cell electrically connected to the drive unit for delivering power to the drive unit;
a battery pack having at least one battery electrically connected to the drive unit for independently delivering power to the drive unit; and
an ultra-capacitor pack having at least one ultra-capacitor electrically connected to the drive unit for independently delivering power to the drive unit.

19. The propulsion system as claimed in claim 18, wherein the fuel cell power module is electrically connected to the battery pack for charging the battery pack.

20. The propulsion system as claimed in claims 18 wherein the drive unit is further connected to the ultra-capacitor pack via a recharge circuit adapted to recharge the ultra-capacitor pack during regenerative braking of the vehicle.

21. The propulsion system as claimed in claim 18 further comprising a controller for receiving a power requirement signal representative of an instantaneous power requirement, the controller having control logic for efficiently coordinating the fuel cell power module, battery pack and ultra-capacitor pack in response to the power requirement signal.

22. The propulsion system as claimed in claim 18 further comprising a controller for receiving a power requirement signal representative of an instantaneous power requirement, the controller causing a battery pack to deliver power to the drive unit when the instantaneous power requirement exceeds a maximum power output of the fuel cell power module and further causing an ultra-capacitor pack to deliver power to the drive unit when the instantaneous power requirement exceeds a combined maximum power output of the fuel cell power module and the battery pack.

23. A hybrid power pack for generating and delivering electric power to equipment having sharply transient power requirements, the power pack comprising:
a power output unit for supplying electric power to the equipment; a fuel cell power module having at least one fuel cell electrically connected to the power output unit for generating and delivering electric power to the power output unit;
a battery pack having at least one battery electrically connected to the power output unit for selectively and independently delivering electric power to the power output unit; and
an ultra-capacitor pack having at least one ultra-capacitor electrically connected to the power output unit for selectively and independently delivering electric power to the power output unit.

24. The power pack as claimed in claim 23 wherein the fuel cell power module is electrically connected to the battery pack for charging the battery pack.

25. The power pack as claimed in claim 23 wherein the power output unit is an electric motor.

26. The power pack as claimed in claim 25 wherein the electric motor is further connected to the ultra-capacitor pack via a recharge circuit adapted to recharge the ultra-capacitor pack when the electric motor is freely rotating.

27. The power pack as claimed in claim 23 further comprising a controller for receiving a power requirement signal representative of an instantaneous power requirement, the controller having control logic for efficiently coordinating the fuel cell power module, battery pack and ultra-capacitor pack in response to the power requirement signal.

28. The power pack as claimed in claim 23 further comprising a controller for receiving a power requirement signal representative of an instantaneous power requirement, the controller causing a battery pack to deliver power to the power output unit when the instantaneous power requirement exceeds a maximum power output of the fuel cell power module and further causing an ultra-capacitor pack to deliver power to the power output unit when the instantaneous power requirement exceeds a combined maximum power output of the fuel cell power module and the battery pack.

29. The power pack as claimed in claim 23 wherein the equipment is an auxiliary power unit (APU) for providing backup power.

30. A method of outputting electric power in response to a sharply transient power requirement, the method comprising the steps of:
receiving a power requirement signal representing an instantaneous power requirement;
processing the power requirement signal to determine whether the instantaneous power requirement can be satisfied by the fuel cell power module alone, by the fuel cell power module supplemented by the battery pack, or by the fuel cell power module supplemented by both the battery pack and the ultra-capacitor pack;
outputting electric power from the fuel cell power module;
supplementing the electric power delivered by the fuel cell power module by also independently outputting electric power from a battery pack when the instantaneous power requirement exceeds a maximum power output of the fuel cell power module; and
supplementing the electric power delivered by the fuel cell power module and the battery pack by also independently outputting electric power from an ultra-capacitor pack when the instantaneous power requirement exceeds a combined maximum power output of the fuel cell power module and the battery pack.

31. The method as claimed in claim 30 further comprising the step of charging the battery pack using current from the fuel cell power module when the instantaneous power requirement is less than the maximum power output of the fuel cell power module.

32. The method as claimed in claim 30 further comprising the step of simultaneously charging both the battery pack and the ultra-capacitor pack using current from the fuel cell power module when the instantaneous power requirement is less than the maximum power output of the fuel cell power module.

33. The method as claimed in claim 30 further comprising the step of charging the ultra-capacitor pack using current generated by a freely rotating electric motor.

34. The method as claimed in claim 30 further comprising the steps of:
transducing an actual total power output of the fuel cell power module, battery pack and ultra-capacitor pack into a feedback signal;
returning the feedback signal to a controller for comparison with a power setpoint that is set by a user; and
controlling the electric power delivered by the fuel cell power module, battery pack and ultra-capacitor pack in response to a difference between the power setpoint and the feedback signal.

35. The method as claimed in claim 30 further comprising the steps of:
transducing an instantaneous power requirement of a connected load into a feedback signal;
returning the feedback signal to a controller for computation using pre-programmed or dynamically changeable control algorithms and parameters to determine a readiness of the power pack to sustain the instantaneous power requirement; and
controlling the fuel cell power module, battery pack and ultracapacitor pack to deliver electric power in response to a difference between a predetermined power setpoint and the feedback signal.
